(19) United States
(12) Patent Application Publication
(10) Pub. No.: US 2015/0328932 A1
(43) Pub. Date: Nov. 19, 2015

(54) Tire Heat Exchange Features

(71) Applicant: BRIDGESTONE AMERICAS TIRE OPERATIONS, LLC, Nashville, TN (US)

(72) Inventor: Brian D. Steenwyk, Uniontown, OH (US)

(21) Appl. No.: 14/652,961

(22) PCT Filed: Dec. 10, 2013
(86) PCT No.: PCT/US13/74110

§ 371 Date: Jun. 17, 2015

Related U.S. Application Data
(60) Provisional application No. 61/739,795, filed on Dec. 20, 2012.

(51) Int. Cl. B60C 11/01; B60C 99/00; B60C 11/11; B60C 5/00; B60C 13/02

(52) U.S. Cl. CPC B60C 11/01; B60C 5/00; B60C 13/02; B60C 11/11; B60C 99/00

(57) ABSTRACT

Provided is a pneumatic tire comprising an axis of operational rotation; a tread defining a cylindrical exterior surface extending both along and around the axis; a first sidewall defining a first sidewall exterior surface; a first shoulder region defining a first shoulder exterior surface; a heat exchange feature on the first shoulder region adapted to modify air flow over an exterior surface; a second sidewall defining a second sidewall exterior surface; a second shoulder region defining a second shoulder exterior surface; and a heat exchange feature on the second shoulder region adapted to modify air flow over an exterior surface. The heat exchange features on the first and second shoulder regions may be adapted to move air during clockwise operational rotation; or the heat exchange features on the first and second shoulder regions may be adapted to move air during counter-clockwise operational rotation.

### TECHNICAL FIELD

The present subject matter relates generally to a tire. More, specifically, the present subject matter relates to a tire comprising one or more heat exchange features.

### BACKGROUND

As a tire operates, it rolls along a surface. As the tire rolls along the surface, the tire material undergoes repeated cycles of strain. The repeated cycles of strain generate heat through hysteresis. That is, operation of a tire tends to generate heat. Typically, a tire is operated in such a way that it will heat up during use, until it reaches a substantially steady state at which time the temperature of the tire is such that the heat generated is equal to the heat output less the heat input.

The rate of heat generation, that is, the heat generated per unit time, is a function of multiple variables including, but not generally limited to, the speed, load, and tire material properties. The heat generated per unit time is generally a positive function of speed; that is, all other variables being equal, higher speeds generate more heat per unit time.

The heat output from the tire takes place through heat transfer mechanisms of conduction, convection, and radiation. The rate of heat output from the tire is generally a positive function of the temperature of the tire; all other variables being equal the higher the temperature of the tire, the greater the heat output per unit time.

Heat generated during operation of the tire will tend to increase the temperature of the tire until the temperature of the tire is high enough to produce a heat output rate equal to the sum of the rate of heat generation plus the rate of heat input.

Temperature is one of the most important variables affecting high speed tire life. It remains desirable to develop tire heat exchange features to affect the rate of heat output from a tire to its environment at a given temperature.

### SUMMARY

Provided is a pneumatic tire comprising an axis of operational rotation; a tread defining a cylindrical exterior surface extending both along and around the axis; a first sidewall defining a first sidewall exterior surface; a first shoulder region defining a first shoulder exterior surface; a heat exchange feature on the first shoulder region adapted to modify air flow over an exterior surface; a second sidewall defining a second sidewall exterior surface; a second shoulder region defining a second shoulder exterior surface; and a heat exchange feature on the second shoulder region adapted to modify air flow over an exterior surface. The heat exchange features on the first and second shoulder regions may be adapted to move air during clockwise operational rotation; or the heat exchange features on the first and second shoulder regions may be adapted to move air during counter-clockwise operational rotation.

### BRIEF DESCRIPTION OF THE DRAWINGS

FIG. 1 is a side view of a tire.

FIG. 2 is a schematic view showing part of the shoulder and tread of one embodiment of a tire comprising heat exchange features.

FIG. 3 is a partial section view of one embodiment of a tire.

FIG. 4 is a schematic view showing part of the shoulder and tread of one embodiment of a tire comprising heat exchange features.

FIG. 5 is a schematic view showing part of the shoulder and tread of one embodiment of a tire comprising heat exchange features.

FIG. 6 is a schematic view showing part of the shoulder and tread of one embodiment of a tire comprising heat exchange features.

FIG. 7 is a thermographic image showing part of a tire tread and a temperature legend.

FIG. 8 is a thermographic image showing part of a tire tread and a temperature legend.

FIG. 9 is a thermographic image showing part of a tire tread and a temperature legend.

FIG. 10 is a thermographic image showing part of a tire tread and a temperature legend.

FIG. 11 is a thermographic image showing part of a tire tread and a temperature legend.

FIG. 12 is a thermographic image showing part of a tire tread and a temperature legend.

FIG. 13 is a thermographic image showing part of a tire tread and a temperature legend.

FIG. 14 is a thermographic image showing part of a tire tread and a temperature legend.

FIG. 15 is a thermographic image showing part of a tire tread and a temperature legend.

FIG. 16 is a thermographic image showing part of a tire tread and a temperature legend.

FIG. 17 is a thermographic image showing part of a tire tread and a temperature legend.

FIG. 18 is a thermographic image showing part of a tire tread and a temperature legend.

FIG. 19 is a thermographic image showing part of a tire tread and a temperature legend.

FIG. 20 is a thermographic image showing part of a tire tread and a temperature legend.

FIG. 21 is a thermographic image showing part of a tire tread and a temperature legend.

FIG. 22 is a thermographic image showing part of a tire tread and a temperature legend.

FIG. 23 is a thermographic image showing part of a tire tread and a temperature legend.

FIG. 24 is a thermographic image showing part of a tire tread and a temperature legend.

FIG. 25 is a thermographic image showing part of a tire tread and a temperature legend.

FIG. 26 is a thermographic image showing part of a tire tread and a temperature legend.

### DETAILED DESCRIPTION

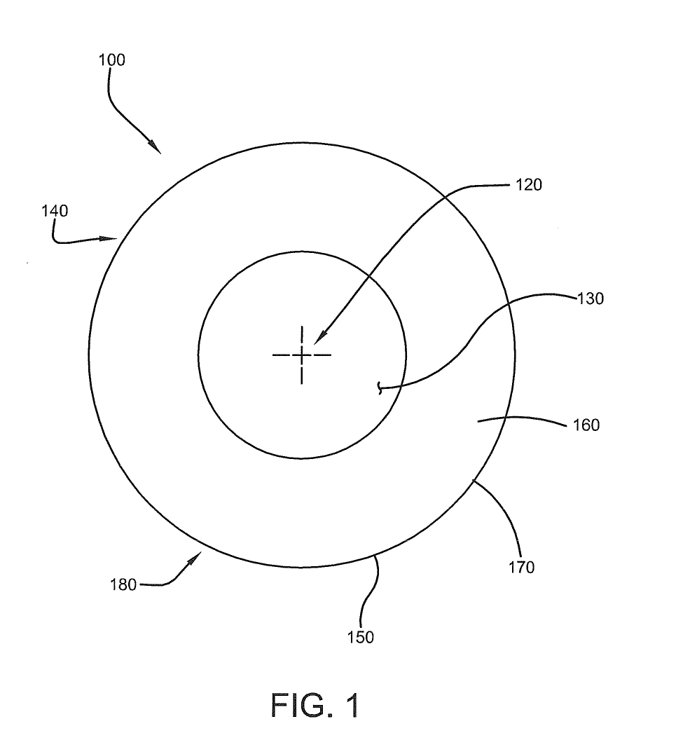

Reference will be made to the drawings, FIGS. 1-26, wherein the showings are only for purposes of illustrating certain embodiments of a tire comprising a heat exchange feature and a method of cooling a pneumatic tire comprising a heat exchange feature.

FIG. 1 shows one embodiment of a tire 100. Without limitation, the tire 100 may comprise a pneumatic tire. The tire 100 comprises an axial direction perpendicular to the view plane in FIG. 1. The axial direction defines an axis 120 of operational rotation. Operational rotation of tire 100 is the rotation about axis 120, either rolling along or slipping on a roadway surface (not shown), that occurs during operational use of the tire. As the term roadway surface is used herein, unless otherwise noted, a roadway surface may be any surface upon which a tire operates, including, but not limited to a road, a track, or a test surface. Operational rotation of the tire about axis 120 may be in either direction; that is, operational rotation may be either clockwise rotation of the tire about axis 120 or counter-clockwise rotation of the tire about axis 120. The tire 100 also defines a plane 130 perpendicular to the axis 120. The tire 100 comprises a substantially circular perimeter that will be referred to herein as circumference 140. The circumference 140 comprises a tread 150. The tread 150 extends both in the direction of the axis 120 and around the axis 120 such that the tread 150 defines a substantially cylindrical surface that may be referred to as a tread exterior surface. The tire 100 also comprises a first face 160 and a second face (not shown). The first face 160 comprises a first sidewall 170 defining a first sidewall exterior surface. The second face (not shown) comprises a second sidewall (not shown) defining a second sidewall exterior surface. The tread 150 and the sidewall 170 define a shoulder region 180 between them. There is a corresponding shoulder region between tread 150 and the second sidewall (not shown) but it is not shown. Shoulder region 180 is the transition region between the adjacent sidewall 170 and tread 150 and being defined by an area therebetween. The shoulder region 180 defines a shoulder exterior surface.

Referring now to the embodiments shown in FIGS. 1-6, the tread 150, 1150, 1250, 1350, 1450, 1550 extends around the circumference 140, 1240 and also extends in the axial direction. The width of the tread 150, 1150, 1250, 1350, 1450, 1550 that is, the tread width, is defined by the extent of the tread in the axial direction. The tread length is the circumferential distance of the tread. The circumferential exterior surface of the tire 100 defined by tread 150 will be referred to as the tread exterior surface. In certain embodiments, a tread comprises a tread pattern 1110, 1210, 1310, 1410, 1510 comprising one or more tread features and one or more gaps therebetween. Without limitation, a tread pattern 1110, 1210, 1310, 1410, 1510 may comprise tread components such as a rib 1112, 1312, 1512 a groove 1114, 1314, 1514 a slot 1116, 1316, 1416, 1516 a block 1118, 1318, 1418, 1518 or a sipe (not shown). A rib 1112, 1312, 1512 is an elongated tread feature that extends substantially circumferentially in a tread 150, 1150, 1250, 1350, 1450, 1550. A groove 1114, 1314, 1514 is an elongated gap. A slot 1116, 1316, 1416, 1516 is an elongated gap. A block 1118, 1318, 1418, 1518 is a tread feature separated from other tread features by one or more grooves 1114, 1314, 1514 and/or one or more slots 1116, 1316, 1416, 1516. A sipe (not shown) is a very thin slot. In some embodiments, tires may have very complex patterns in which ribs or grooves are not well defined as distinct entities.

A sidewall 170, 1170, 1270, 1370, 1470, 1570 extends circumferentially and radially. The sidewall 170, 1170, 1270, 1370, 1470, 1570 defines an exterior surface. The exterior surface of the tire 100 defined by an individual sidewall 170, 1170, 1270, 1370, 1470, 1570 will be referred to as a sidewall exterior surface. In certain embodiments, a sidewall will comprise a sidewall pattern 1130, 1330, 1430, 1530 comprising one or more sidewall features and one or more gaps therebetween. Without limitation, a sidewall pattern 1130, 1330, 1430, 1530 may comprise sidewall components such as a slot 1132, 1332, 1432, 1532 or a block 1134, 1334, 1434, 1534. A slot 1132, 1332, 1432, 1532 is an elongated gap. A block 1134, 1334, 1434, 1534 is a sidewall feature separated from other sidewall features by one or more slots 1132, 1332, 1432, 1532.

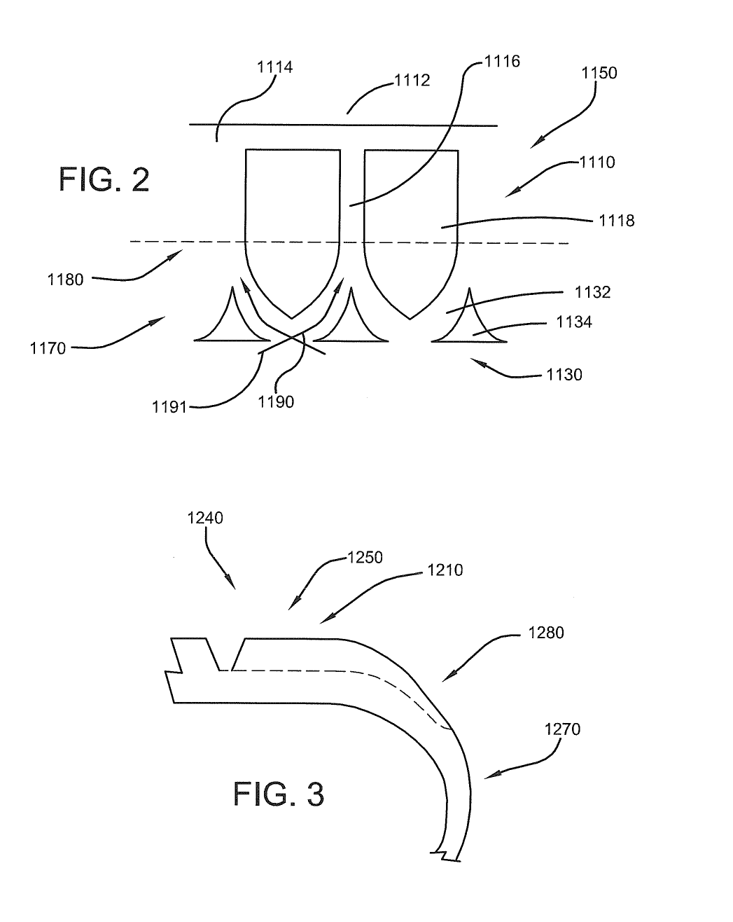

A shoulder region 180, 1180, 1280, 1380, 1480, 1580 is a region defined by the adjacent tread 150, 1150, 1250, 1350, 1450, 1550 and sidewall 170, 1170, 1270, 1370, 1470, 1570. As can be seen in the embodiment shown FIG. 5, the sidewall features of the sidewall 1470 may gradually transition into the tread features 1450. The transition of these features may take place in the shoulder region 1480. In certain embodiments, such as, without limitation, those shown in FIGS. 2, 4-6, the features of the sidewall 170, 1170, 1270, 1370, 1470, 1570 may be integrally connected with, and transition into, analogous features of the tread 150, 1150, 1250, 1350, 1450, 1550. As can be seen in the embodiment shown FIG. 5, the shoulder features of the shoulder 1480 may gradually transition into the tread features 1450. The transition of these features may take place between the shoulder region 1480 and the tread features 1450. In certain embodiments, such as, without limitation, those shown in FIGS. 2, 4-6, the features of the shoulder 180, 1180, 1280, 1380, 1480, 1580 may be integrally connected with, and transition into, analogous features of the tread 150, 1150, 1250, 1350, 1450, 1550. As will be described more fully herebelow, some of the above-referenced features 1470, 1480 that gradually transition into other features 1450 may be heat exchange features.

In certain embodiments, certain features of a sidewall, or certain features of a shoulder, or certain features of a tread may function as heat exchange features during operation of the tire 100. Heat exchange features 110, 1118, 1132, 1134, 1318, 1332, 1334, 1418, 1432, 1434, 1518, 1532, 1534 may promote heat exchange via convection. As noted above, tire operation comprises rotation of the tire as it rotates and rolls, with or without some slippage, along a roadway surface. During tire operation, air in the surrounding environment flows over one or more portions of the tire as the tire, or at least a portion of the tire, moves through the surrounding air. Heat exchange features 110, 1118, 1132, 1134, 1318, 1332, 1334, 1418, 1432, 1434, 1518, 1532, 1534 may be adapted to promote heat exchange between the tire and the air of the surrounding environment by convection. A heat exchange feature adapted to promote heat exchange between the tire and the air of the surrounding environment by convection may act to modify air flow over one or more of the exterior surfaces of the tire by scooping, impelling, inducting or otherwise moving air from a first area of the tire, for example and not limitation the shoulder 180, 1180, 1280, 1380, 1480, 1580, to a second area of the tire, for example and not limitation the tread 150, 1150, 1250, 1350, 1450, 1550.

A heat exchange feature 110, 1118, 1132, 1134, 1318, 1332, 1334, 1418, 1432, 1434, 1518, 1532, 1534 may comprise an internal feature or an external feature. An internal feature may be a groove, gap, slot, or other cavity in a surface of the tire 100 such as, without limitation, groove 1114, 1314, or slot 1116, 1316. An external feature may be a fin, a blade, a stud, a block, or another projection from a surface of the tire 100, 400 such as, without limitation, block 1118, 1318. It should be understood that the functional nature of a heat exchange feature adapted to promote heat exchange through convection is provided by its ability to move air. This ability to move air is provided in part by the surfaces defining the heat exchange features. In certain embodiments, a surface defining a heat exchange feature may be defined by an adjacent heat exchange feature. By way of example, and without limitation, the heat exchange feature 1116 is defined in part by the bordering surface of heat exchange feature 1118. Also by way of example, and without limitation, the heat exchange feature 1334 is defined in part by the bordering surface of heat exchange feature 1332.

Heat exchange features may be elongated, non-elongated, substantially linear, or curved. In embodiments such as those shown in FIGS. 2, 4-6 heat exchange features 1134, 1118, 1334, 1318, 1434, 1418, 1518 may be only slightly elongated or irregular in shape. As shown in FIG. 6 heat exchange features 1518 may be curved.

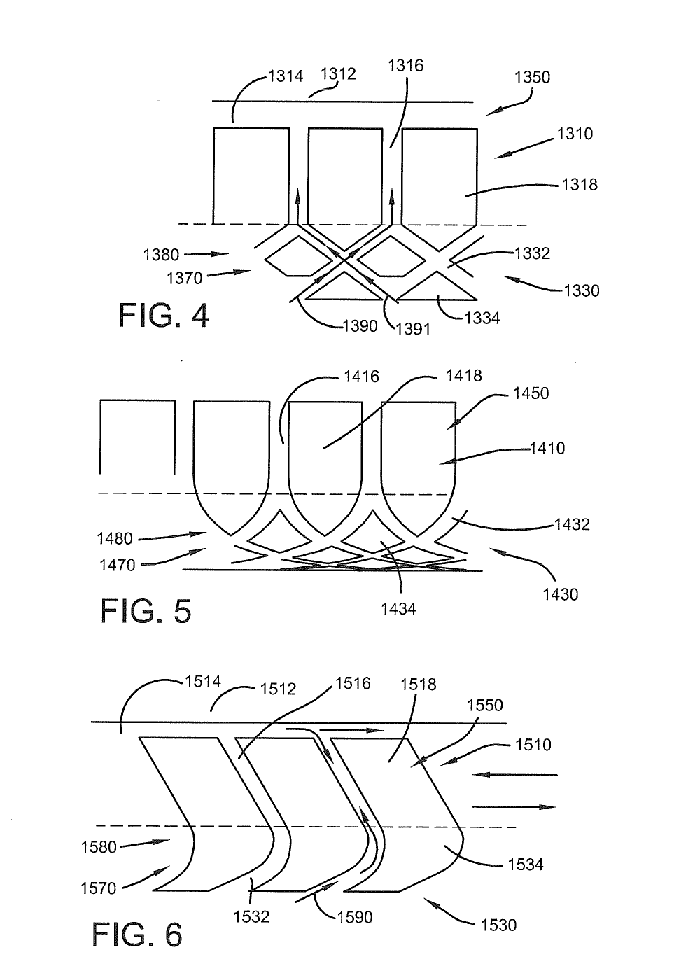

In certain embodiments, a heat exchange feature may operate to modify air flow over the tire such that the air flow is moved from a first area of the tire to a second area of the tire. In the embodiments shown in FIGS. 2 and 4-6, the tire comprises heat exchange features 1132, 1134, 1332, 1334, 1432, 1434, 1532, 1534 adapted to move air from the shoulder region toward the tread. The embodiments shown in FIGS. 2 and 4-5 all comprise a set of blocks 1134, 1334, 1434 separated by slots 1132, 1332, 1432. The arrangement of these blocks 1134, 1334, 1434 and slots 1132, 1332, 1432 creates a geometry that acts to impel or otherwise move air from the shoulder region 1180, 1380, 1480 toward the tread 1150, 1350, 1450 and thereby creating an air flow 1190, 1390 when rotated in one direction and creating an air flow 1191, 1391 when rotated in the opposite direction. That is, the arrangement of these blocks 1134, 1334, 1434 and slots 1132, 1332, 1432 acts as a kind of impeller to induce air to flow from the shoulder region 1180, 1380, 1480 toward the tread 1150, 1350, 1450. In certain embodiments, the slots 1132, 1332, 1432 which form the channels in which the air flow 1190, 1390, 1191, 1391 flows along, are integrally part of, or are aligned with, or are fluidly connected with, slots in the tread 1116, 1316. Without limitation, in the embodiments shown in FIGS. 2 and 4-6, the tire comprises heat exchange features 1132, 1134, 1332, 1334, 1432, 1434, 1532, 1534 adapted to move air from the shoulder region into the tread region. As shown in the embodiment depicted in FIG. 4, in some embodiments the air flow 1390 may flow from the shoulder region 1380 and into one or more slots 1316 in the tread.

In some embodiments, heat exchange features may create or accentuate air flow over regions of the tire that, absent the heat exchange features would have little or no air flow. In certain embodiments, the tread 1150, 1350, 1450 of a tire 100 would have little or no air flow thereover during operation absent the heat exchange features 1132, 1134, 1332, 1334, 1432, 1434, 1532, 1534. In such embodiments, without the heat exchange features 1132, 1134, 1332, 1334, 1432, 1434, 1532, 1534 the tread 1150, 1350, 1450 of the tire 100 has a substantially higher steady state operating temperature than it would with the heat exchange features 1132, 1134, 1332, 1334, 1432, 1434, 1532, 1534.

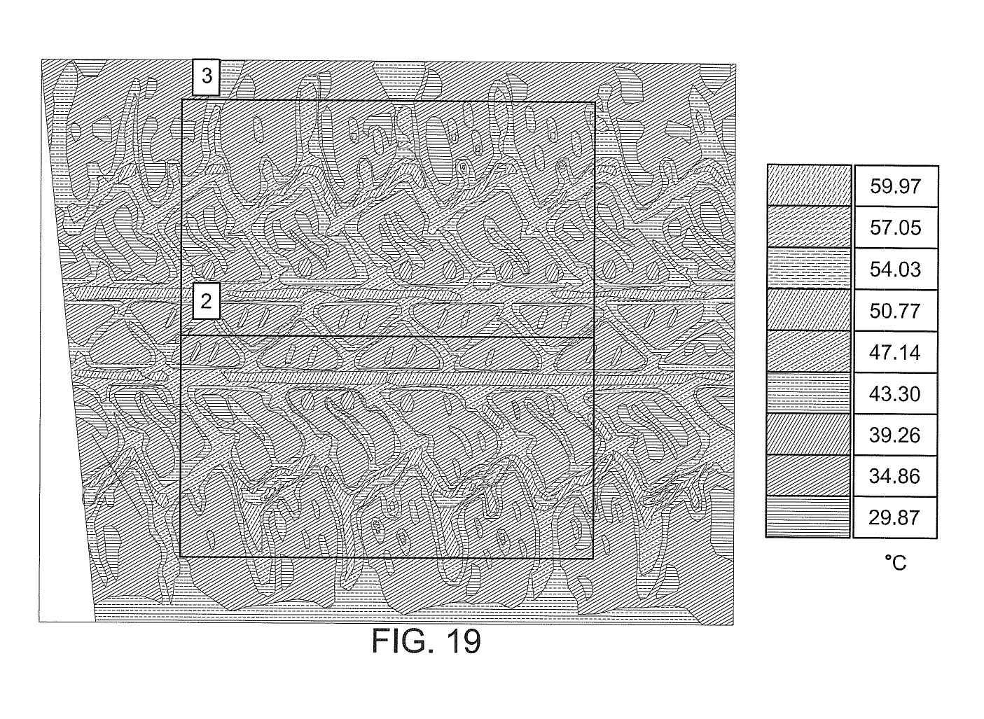

As noted above, the embodiments shown in FIGS. 2 and 4-5 all comprise an arrangement of blocks 1134, 1334, 1434 and slots 1132, 1332, 1432 that creates a geometry that may act to impel or otherwise move air from the shoulder region 1180, 1380, 1480 toward the tread region 1150, 1250, 1350, 1450, 1550 and thereby creating an air flow 1190, 1390, 1191, 1391. The heat exchange features 1118, 1132, 1134, 1318, 1332, 1334, 1418, 1432, 1434, shown in FIGS. 2 and 4-5 are substantially symmetric about any given plane through axis 120 of the tire 100. Due to this symmetry, the heat exchange features 1118, 1132, 1134, 1318, 1332, 1334, 1418, 1432, 1434, function equally well when the tire is rotated clockwise as when the tire is rotated counter-clockwise. That is, in the embodiments shown in FIGS. 2 and 4-5, the heat exchange features are adapted to function to create an air flow 1190, 1390, 1191, 1391 that is not dependent upon the tire rotating in one particular direction about the axis 120. The heat exchange features function to create an air flow 1190, 1390 that moves air from a first region of the tire to a second region of the tire when the tire undergoes operational rotation clockwise, and the heat exchange features function to create an air flow 1191, 1391 that moves air from a first region of the tire to a second region of the tire when the tire undergoes operational rotation counter-clockwise. Heat exchange features 1118, 1132, 1134, 1318, 1332, 1334, 1418, 1432, 1434 may be used with tires having point-symmetric tread patterns that are designed to rotate in both directions. In certain embodiments, a tread pattern and/or a heat exchange feature of a tire may be substantially point-symmetric. As the term point symmetric is used herein, unless otherwise noted, it refers to local symmetry in which an object is substantially invariant under a point reflection. Non-limiting examples of point symmetric tread patterns are shown in FIGS. 19-22 and FIGS. 23-26.

The embodiment shown in FIG. 6 comprises an arrangement of blocks 1518, 1534 and slots 1532, 1516 that creates a geometry that acts to move air from shoulder region 1580 toward the tread region 1550 and thereby creating an air flow 1590. The heat exchange features 1534 and 1532, shown in FIG. 6 are asymmetric about any given plane through axis 120 of the tire 100. Due to this asymmetry, the heat exchange features have a directional bias such that they function well when the tire is rotated in a first direction and not as well or not at all when the tire is rotated in a direction opposite the first direction. Hereafter the terms clockwise and counter-clockwise will be used to refer to tire rotational direction. The terms clockwise and counter-clockwise are non-limiting and are used purely for reference and discussion purposes; for purposes of this discussion and without limitation, clockwise is defined from the viewing position directed toward the first sidewall as shown in FIG. 1 and in the other Figures showing part or all of a tire side view; counter-clockwise is the opposite direction. That is, the embodiment shown in FIG. 6 shows heat exchange features 1518, 1532, 1534 with a clockwise directional bias such that they are adapted to induct or move air from shoulder region 1580 and toward one or more slots 1516 of tread 1550 thereby creating air flow 1590 during clockwise operational rotation. By contrast, because of the clockwise directional bias, heat exchange features 1518, 1532, 1534 are not adapted to modify air flow by induction of air from shoulder region 1580 into one or more slots 1516 of tread 1550 during counter-clockwise operational rotation. By extension, a mirror image (not shown) of the embodiment shown in FIG. 6 would have a counter-clockwise directional bias such that they would be adapted to modify air flow by induction of air from shoulder region 1580 into one or more slots 1516 of tread 1550 during counter-clockwise operational rotation, but would not be adapted to modify air flow by induction of air from shoulder region 1580 into one or more slots 1516 of tread 1550 during clockwise operational rotation. One use of a directionally biased heat exchange feature is with a tire having a directional tread pattern that is designed to rotated in only one direction.

### Example 1

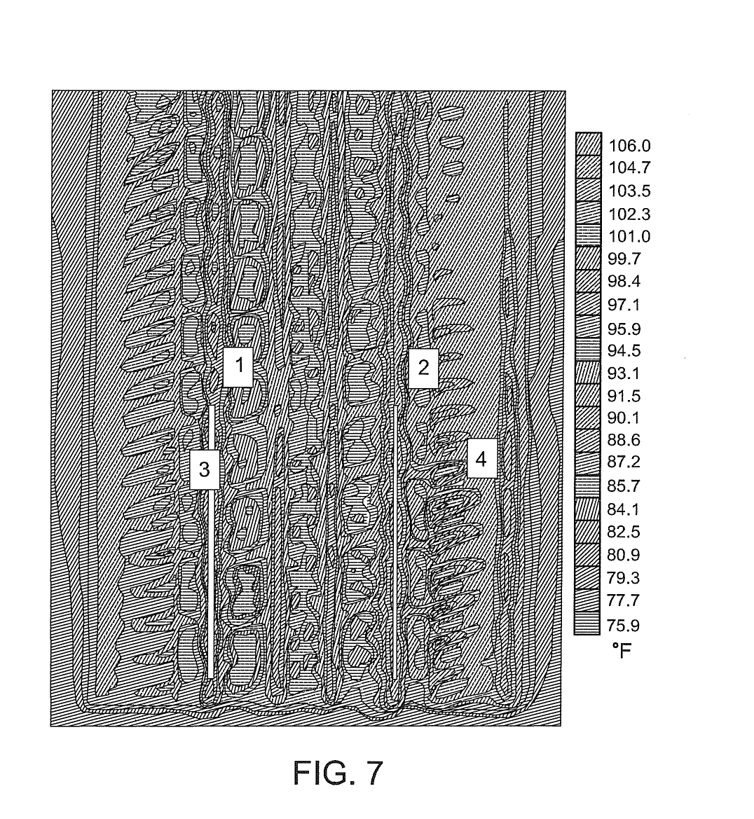

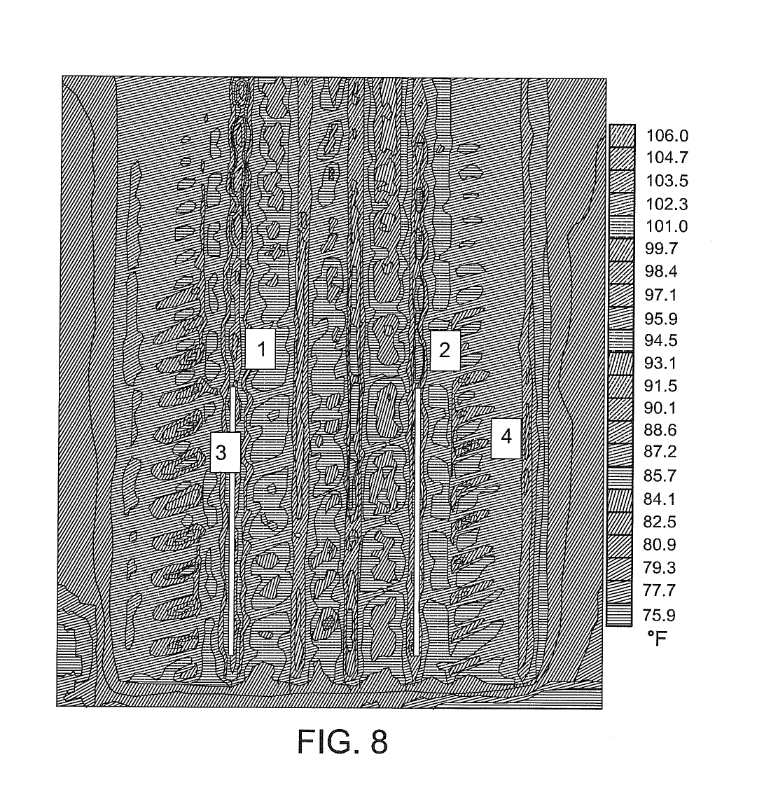

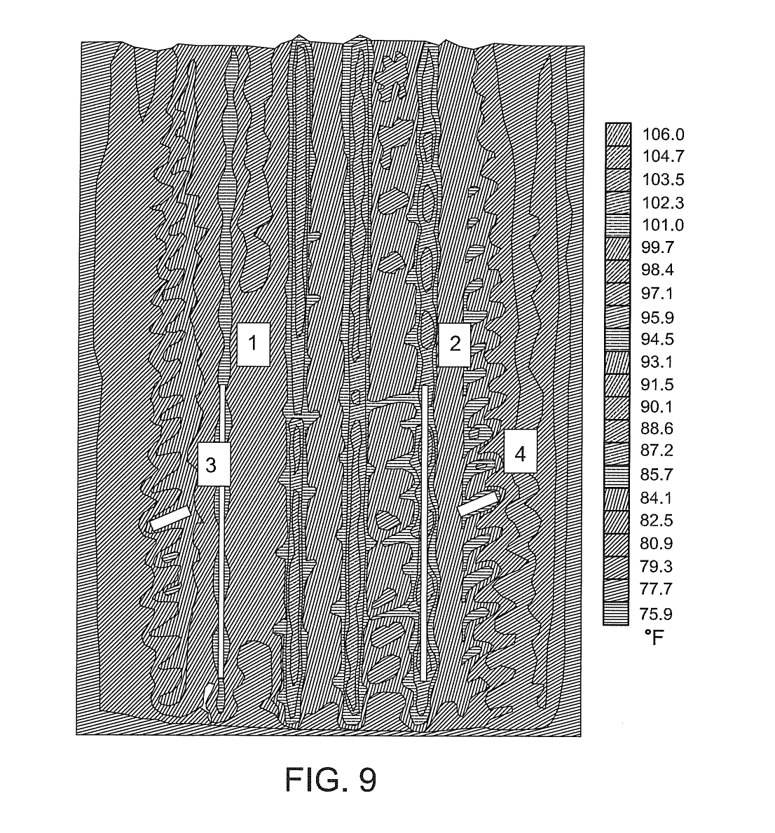

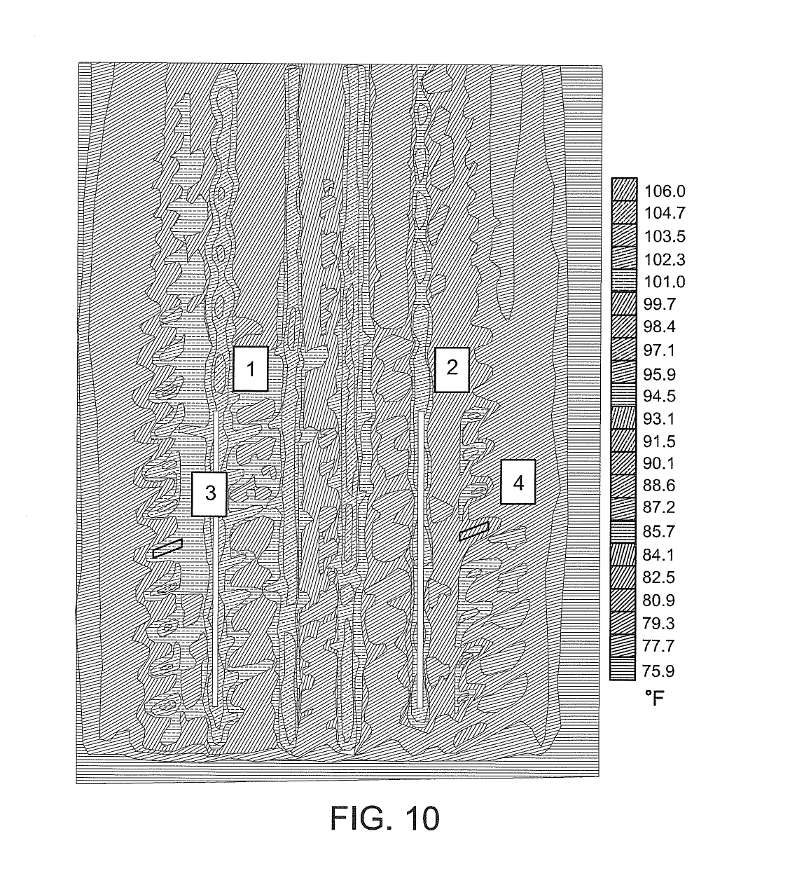

Testing was performed on a P215/70R15 tire of a first specification code 01-100, at 80 mph and 28.5 psi. The tread pattern of the first tire comprised a first set of slots capable of moving air into the tread when rotated in a first direction and a second set of slots capable of moving air into the tread when rotated in a second direction opposite the first direction. The first set of slots was formed by slots along the perimeter of the tire as part of the tread pattern adjacent to the first shoulder region. The second set of slots were formed by slots along the perimeter of the tire as part of the tread pattern adjacent to the second shoulder region, that is, the shoulder region on the opposite side of the tire from the first shoulder region. The slots in each of the first and second sets of slots each had a bias as shown by the thermographic images in FIGS. 7-10 such that rotation of the tire in an air flow resulted in the air flow on one side being inducted into the slots, into the shoulder region on the same side, and into the tire tread on the same side. A first test run was conducted on a first tire of specification code 01-100 by testing it under a 1000 lb load rotating at 80 mph on a test drum for 15 minutes clockwise with a relative air flow in a first direction parallel to the tire. A thermographic image of the tire tread of the first tire at the end of the first test run in shown in FIG. 7. All thermographic images were taken while the tire was still loaded and rotating. For the first testing run, the first direction of the air flow was perpendicular to the axis of rotation of the tire and in the upward direction of the image. A second test run was conducted on a tire of the first specification code 01-100 by testing it under a 1000 lb load rotating at 80 mph for 15 minutes counter-clockwise with an air flow in a second direction opposite that of the first direction, downward in FIG. 8, but still perpendicular to the axis of rotation of the tire. A thermographic image of the tire tread of the tire at the end of the second test run is shown in FIG. 8. A third test run was conducted on a tire of the first specification code 01-100 by testing it under a 1000 lb load rotating at 80 mph for 15 minutes counter-clockwise with an air flow in the first direction and then 5 minutes clockwise with an air flow in the first direction under a minimal load of 20 lb. In other words, the tire was run while rotating counter-clockwise under a high load, heating it, and was run clockwise under a low load but with an air flow to cool it. A thermographic image of the tire tread of the tire at the end of the third test run is shown in FIG. 9. The hot side in FIG. 9 is on the right. This is evidence that the side-to-side temperature difference observed in FIGS. 7 and 8 is caused by air flow within the tread pattern rather than some other asymmetry in the tire or test such as plysteer, conicity, or the machine geometry. A fourth test run was conducted on a tire of the first specification code 01-100 by testing it under a 1000 lb load rotating at 80 mph for 15 minutes counter-clockwise with the air flow in the second direction opposite that of the first direction and then 5 minutes counter-clockwise with the air flow in the second direction. In other words, the tire was run while rotating counter-clockwise under a high load, heating it, and was run counter-clockwise under a low load but with an air flow to cool it. A thermographic image of the tire tread of the first tire at the end of the fourth test run in shown in FIG. 10. As in FIG. 9, the hot side of FIG. 10 was on the left side of the image. This is evidence that the side-to-side temperature difference observed in FIGS. 7 and 8 is caused by air flow within the tread pattern rather than some other asymmetry in the tire or test such as plysteer, conicity, or the machine geometry.

### Example 2

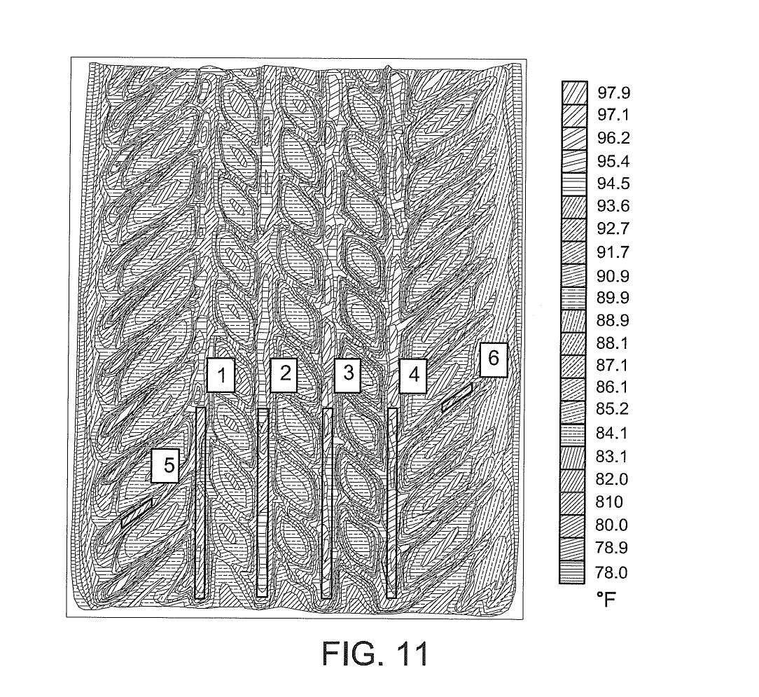

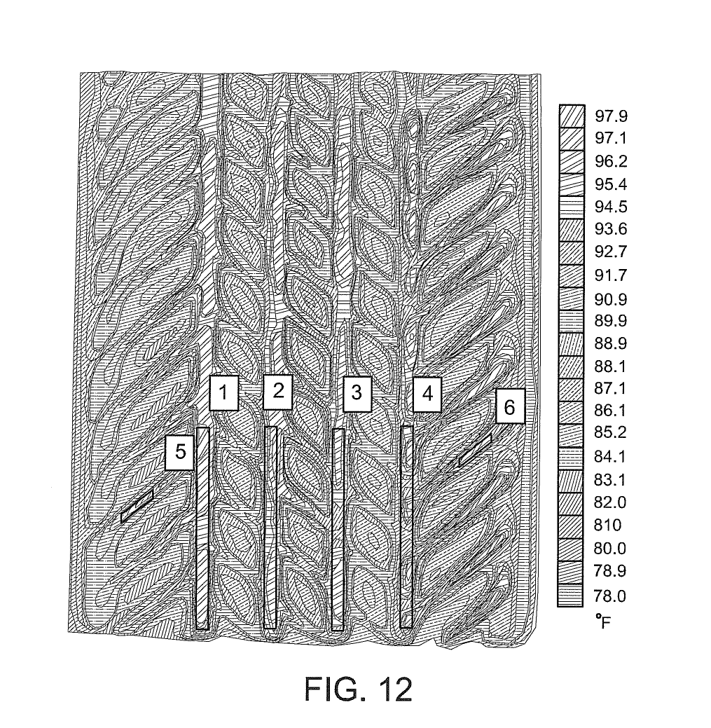

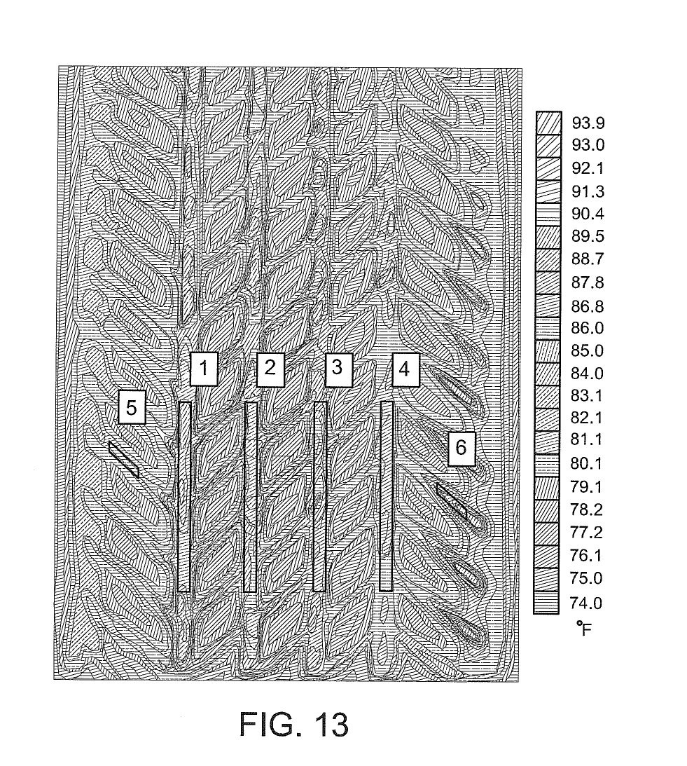

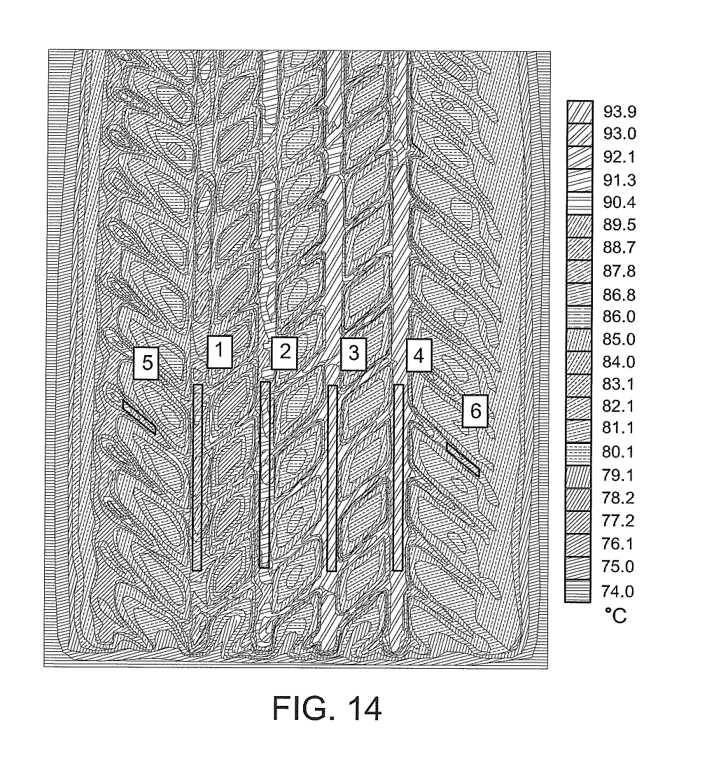

Testing was performed on a first P245/50R18 tire of a second specification code 02-200, hand cut to have a tire tread pattern described below, and upon a second 02-200 tire of the second specification code 02-200 hand cut to have a mirror image of the first 02-200 tire tread pattern. Both the first 02-200 tire and the second 02-200 tire were tested at 80 mph and 36 psi on a test drum. The first 02-200 tire tread pattern was hand cut so that the first tire shoulder rib comprised a first set of hand cuts to define a first set of biased heat exchange features and the second tire shoulder rib comprised a second set of hand cuts to define a second set of biased heat exchange features. The first set of heat exchange features was cut along the perimeter of the tire proximate the tread pattern adjacent to the first shoulder region. The second set of heat exchange features were cut along the perimeter of the tire proximate to the tread pattern adjacent to the second shoulder region, that is, the shoulder region on the opposite side of the tire from the first shoulder region. The first set of heat exchange features had a clockwise bias. The second set of heat exchange features had a bias opposite from that of the first set of heat exchange features such that no matter which direction the tire was rotated, only one of the two sets of heat exchange features were inducting air. A first test run was conducted on the first 02-200 tire by testing it under a 1000 lb load rotating at 80 mph for 20 minutes counter-clockwise with a relative air flow in a first direction parallel to the tire. It should be noted that for heat exchange purposes, air flowing over the tire and the tire moving through the air both create relative air flow. A thermographic image of the tire tread at the end of the first test run is shown in FIG. 11. For the first testing run, the first direction air flow was perpendicular to the axis of the tire and in the downward direction as shown in FIG. 11. A second test run was conducted on the first 02-200 tire by testing it under a 1000 lb load rotating at 80 mph for 17 minutes clockwise with a relative air flow in a second direction opposite that of the first direction. A thermographic image of the tire tread at the end of the second test run is shown in FIG. 12. A first test run was conducted on the second 02-200 tire by testing it under a 1000 lb load rotating at 80 mph for 20 minutes counter-clockwise with an air flow in the first direction. A thermographic image of the tire tread of the second 02-200 tire at the end of the first test run on it is shown in FIG. 13. A second test run was conducted on the second 02-200 tire by testing it under a 1000 lb load rotating at 80 mph for 17 minutes clockwise with an air flow in the second direction. A thermographic image of the tire tread at the end of the second test run on the second 02-200 tire is shown in FIG. 14. Referring now to FIGS. 11-14, in each of the thermographic images from the tests on the first 02-200 tire and the second 02-200 tire, on the side of the tread corresponding to the side into which air was being inducted, the tire tread is cooler than the opposite side. The cooler side is cooler by approximately 2-8 degrees Fahrenheit. Based on the data in this example, shoulder slots angled into the air flow are cooler, and grooves losing air to adjacent slots are cooler than are similar grooves receiving air from adjacent slots.

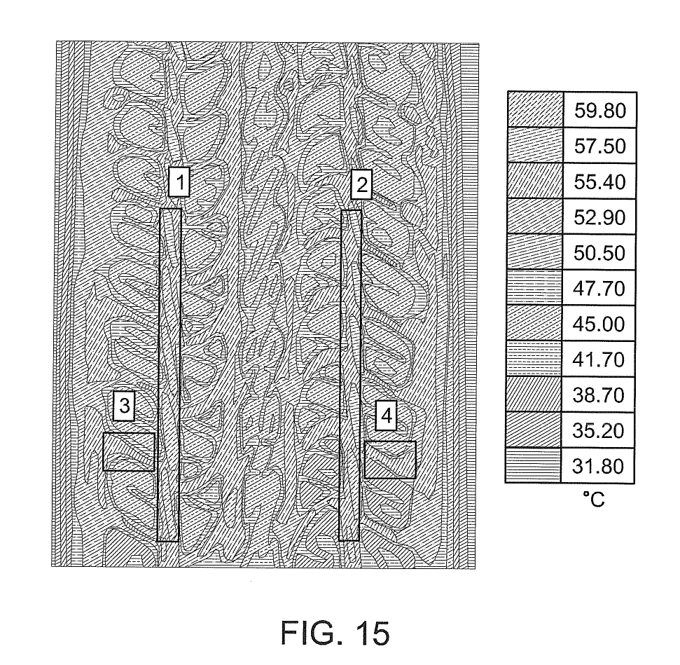

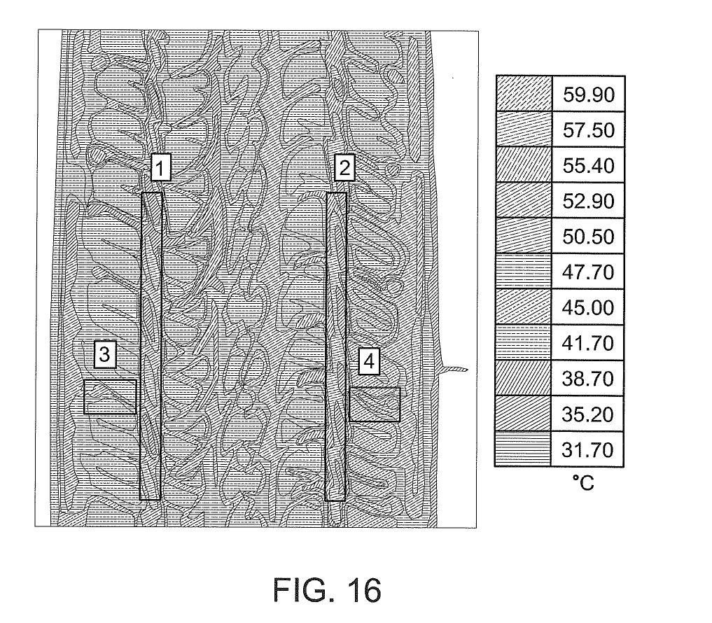

Thermographic images showing the results of similar testing on another tire specification are shown in FIGS. 15 and 16.

### Example 3

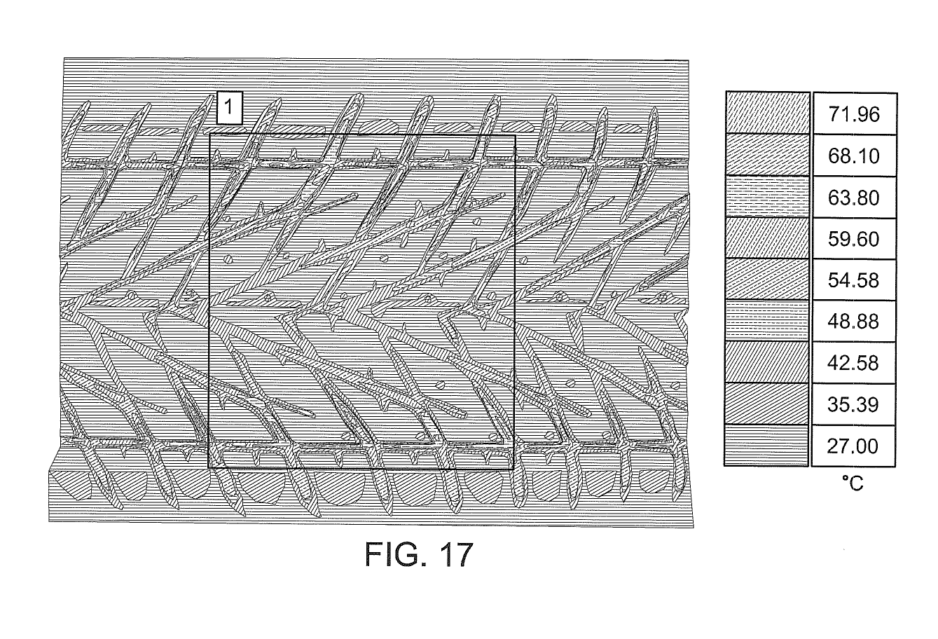

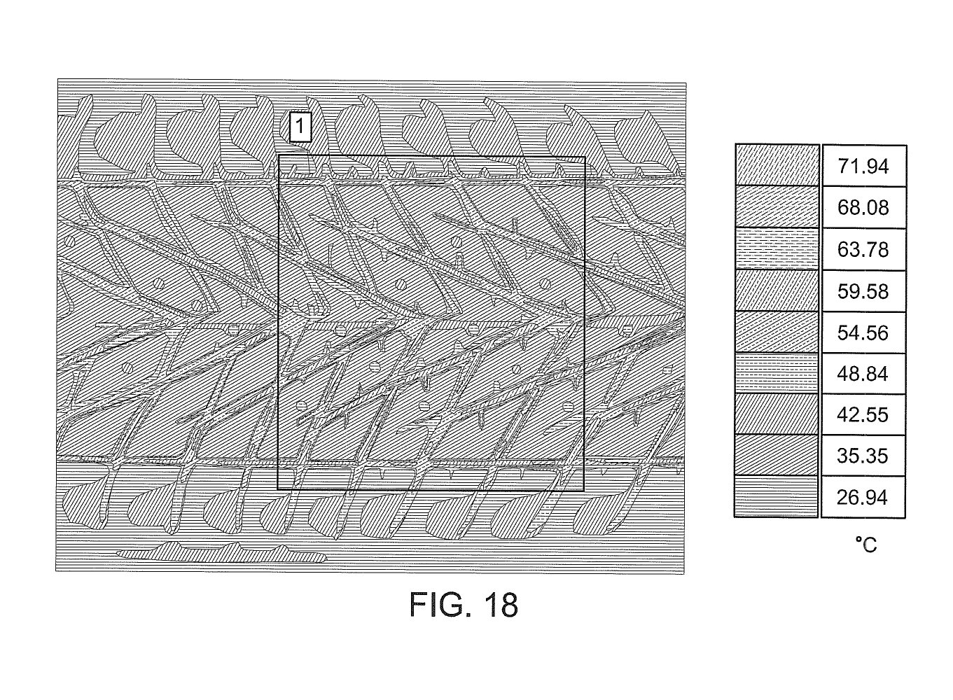

Testing was performed on P215/50R17 tire of specification code Q-100 at 155 mph, under a 1005 lbf load on a 10 foot diameter steel drum, in an ambient temperature of 74 Fahrenheit, inflated to 44 psi for 30 minutes. Tires of specification code Q-100 have a tread pattern that is directional; that is, the tread pattern has a directional bias and is intended to be rotated in a certain direction. Thermographic data regarding the tire was taken with a Cedip Silver 420M IR camera. Contained air temperature data (CAT) was also taken using a Beru tire pressure and temperature monitoring sensor. In a first test run, a tire of specification code Q-100 was mounted as shown in FIG. 17 and was tested with a relative air flow from left to right. In other words, the tire surface was moving from right to left as shown in FIG. 17. As shown in FIG. 17 the directional bias of the tread of the tire when rotated as intended as noted above is such that air flow from left to right in the orientation shown will tend not to move air from the shoulder and into the tread. As shown in FIG. 17, the temperature along the circumferential slots along the periphery of the tread is substantially higher than the temperature in the middle region of the tread. The CAT of the tire in FIG. 17 was 133 Fahrenheit. In a second test run, a tire of specification code Q-100 was mounted as shown in FIG. 18 and was tested with a relative air flow from left to right when rotated opposite the intended direction as noted above. As shown in FIG. 18 the directional bias of the tread of the tire is such that air flow from left to right in the orientation shown will tend to scoop air into the tread. As shown in FIG. 18, the temperature along the circumferential slots along the periphery of the tread is substantially cooler than the temperature in the middle region of the tread. The CAT of the tire in FIG. 18 was 135 Fahrenheit. SAE high speed durability test were conducted on three tires of specification code Q-100 that were mounted as shown in FIG. 17 and on three tires of specification code Q-100 that were mounted as shown in FIG. 18. When the durability tested tires of specification code Q-100 were rotated in the cooler direction, they tended to last longer by 5.8 minutes.

### Example 4

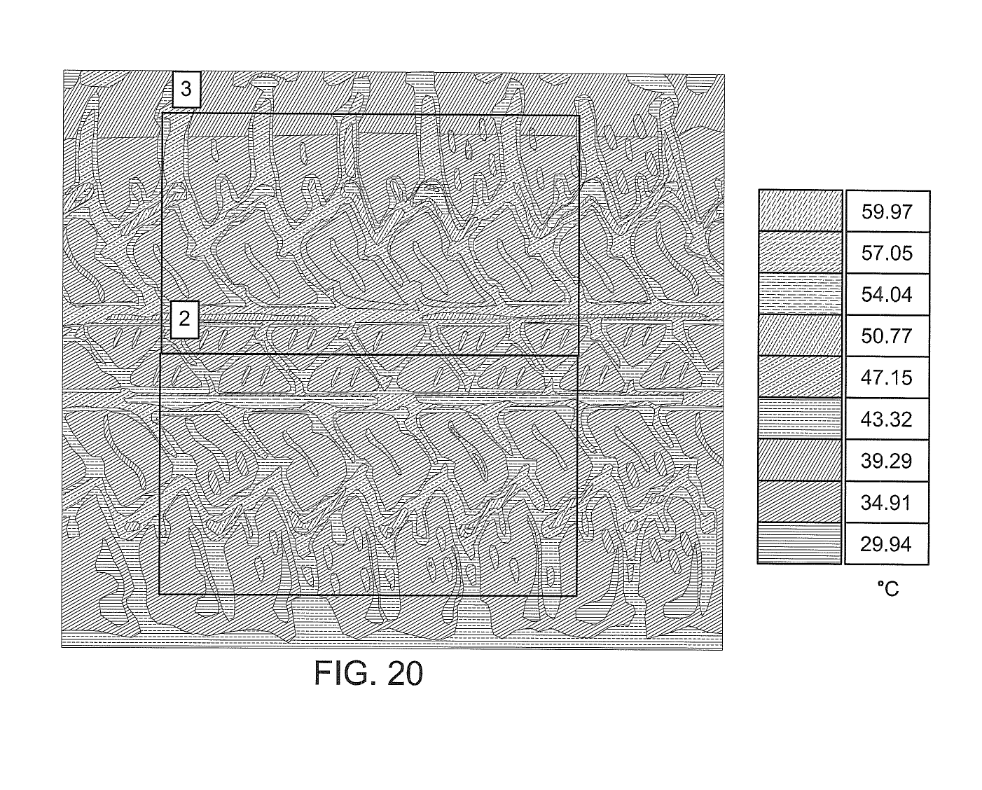

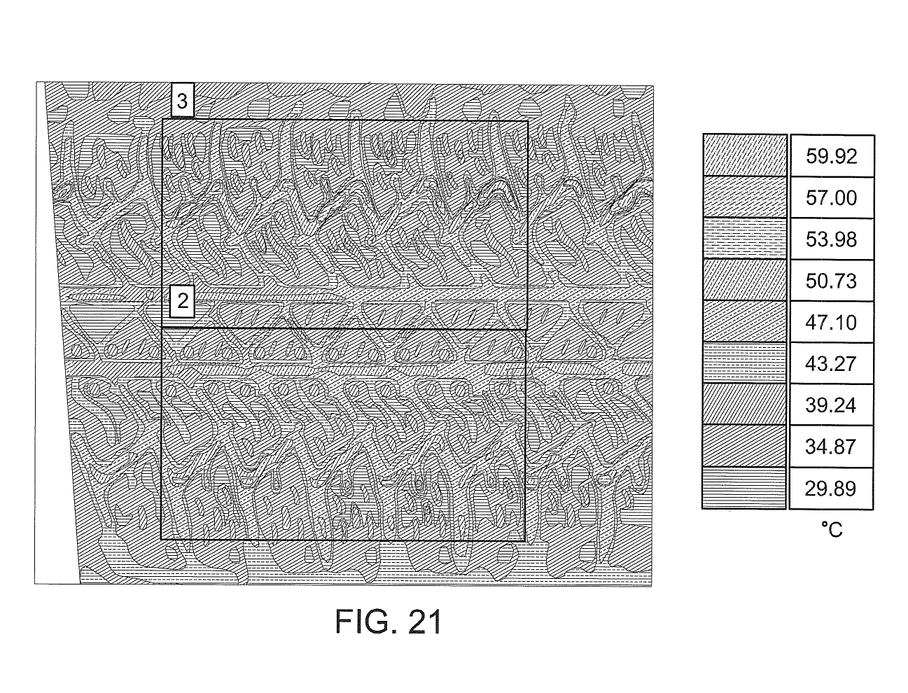

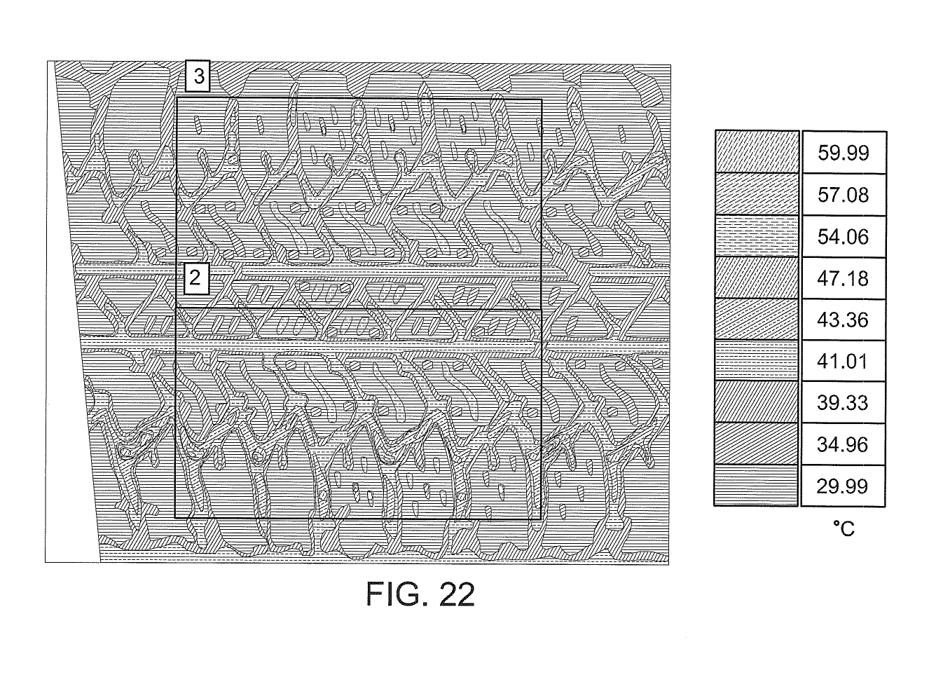

Testing was performed on a P265/70R17 tire of specification code R-100 at 112 mph, under a 2028 lbf load, on a 10 foot diameter steel drum, in an ambient temperature of 74 Fahrenheit, inflated to 41 psi until the tire reached a steady state temperature Tires of specification code R-100 have a tread pattern that is point-symmetric. Thermographic data regarding the tire was taken with a Cedip Silver 420M IR camera. Contained air temperature data (CAT) was also taken using a Beru sensor. As shown in FIGS. 19-22 the point symmetric tread pattern of an R-100 tire is such that, in whichever direction it is run, on one side of the tire it tends to move air from the shoulder and into the tread, but on the other side of the tire it does not. In a first test run, a tire of specification code R-100 was mounted as shown in FIG. 19, with the serial side out, and was tested with a relative air flow from left to right and with tire circumferential motion from right to left. The resulting thermographic scan of the tire as tested in the first test run is shown in FIG. 19. As shown in FIG. 19, the temperature measured along the side of the tire shown proximate to the bottom of the figure was substantially higher than the temperature measured along the side of the tire shown proximate to the top of the figure. The CAT of the tire in FIG. 19 was 149 Fahrenheit. In a second test run, a tire of specification code Q-100 remained mounted serial side out, and was tested with a relative air flow from right to left and with tire circumferential motion from left to right. The resulting thermographic scan of the tire as tested in the second test run is shown in FIG. 20. As shown in FIG. 20, the temperature measured along the side of the tire shown proximate to the bottom of the figure was substantially lower than the temperature measured along the side of the tire shown proximate to the top of the figure. The CAT of the tire in FIG. 20 was 151 Fahrenheit. In a third test run, a tire of specification code Q-100 was mounted as shown in FIG. 21, with the serial side in, and was tested with a relative air flow from right to left and with tire circumferential motion from left to right. The resulting thermographic scan of the tire as tested in the third test run is shown in FIG. 21. As shown in FIG. 21, the temperature measured along the side of the tire shown proximate to the bottom of the figure was substantially lower than the temperature measured along the side of the tire shown proximate to the top of the figure. The CAT of the tire in FIG. 21 was 151 Fahrenheit. In a fourth test run, a tire of specification code Q-100 was mounted as shown in FIG. 22, with the serial side in, and was tested with a relative air flow from left to right and with tire circumferential motion from right to left. The resulting thermographic scan of the tire as tested in the fourth test run is shown in FIG. 22. As shown in FIG. 22, the temperature measured along the side of the tire shown proximate to the bottom of the figure was substantially higher than the temperature measured along the side of the tire shown proximate to the top of the figure. The CAT of the tire in FIG. 22 was 154 Fahrenheit. The same tire of specification Q-100 was run in all four test runs. It should be noted that the data in Example 4 supports the conclusion that the hot side of the tread pattern switches sides when the rotation direction is switched.

### Example 5

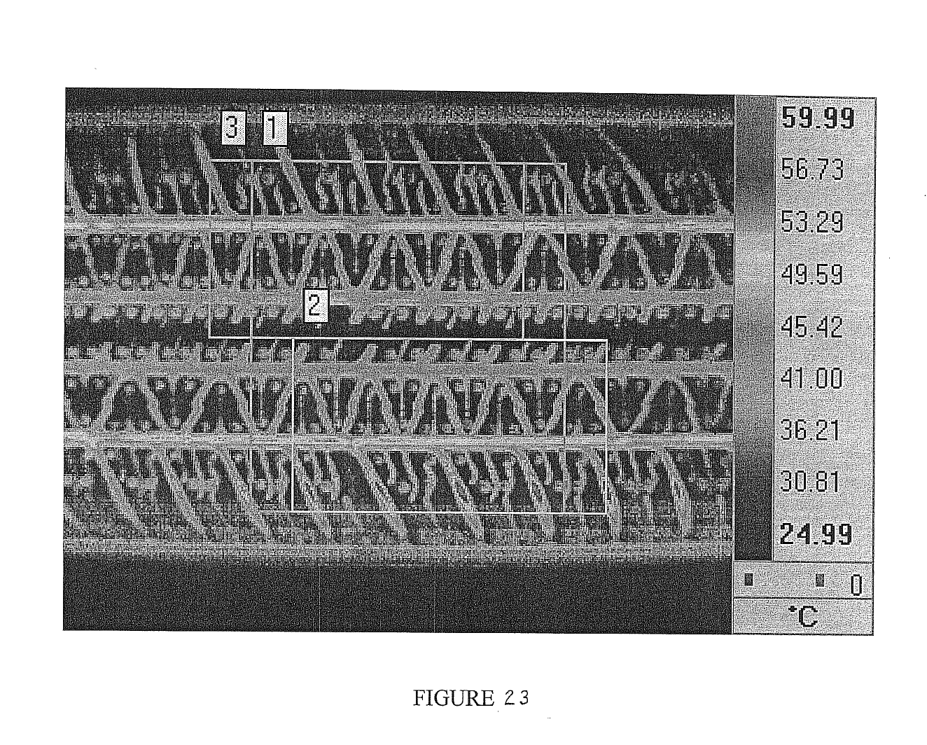

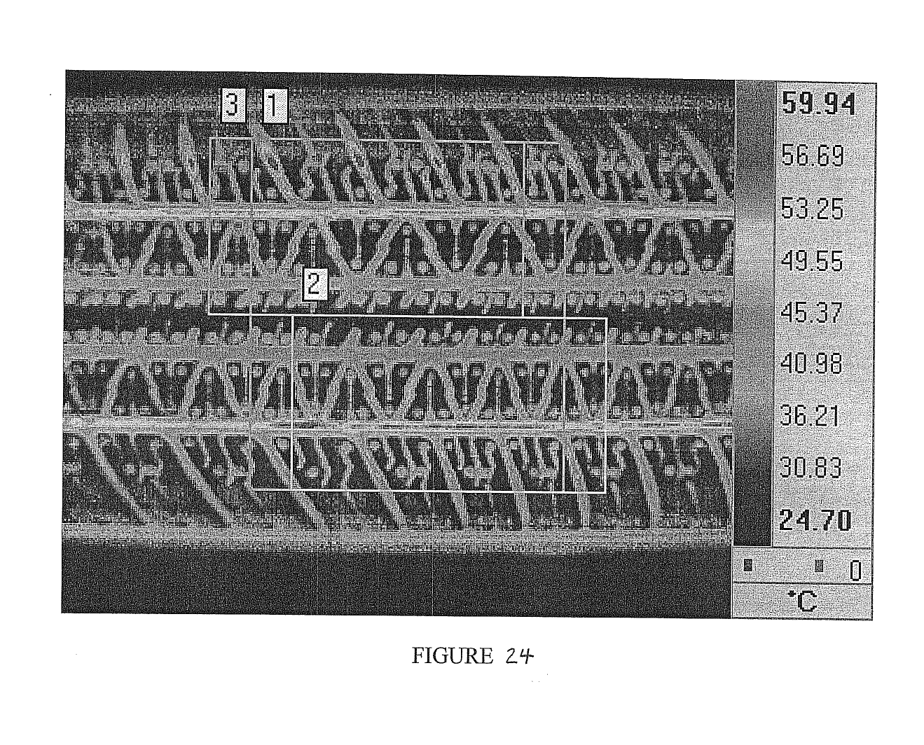

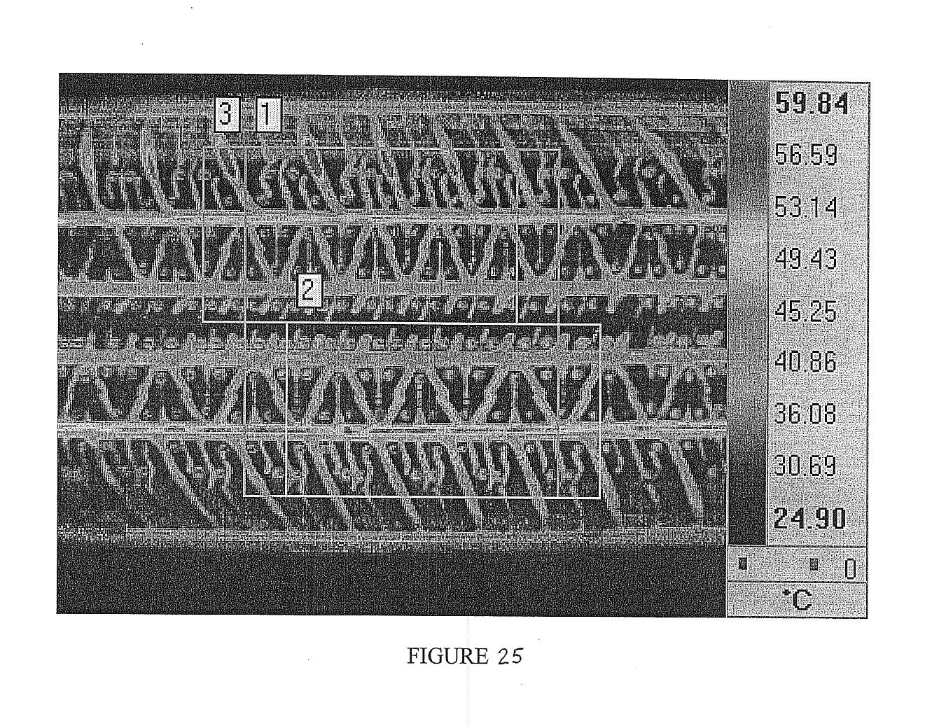

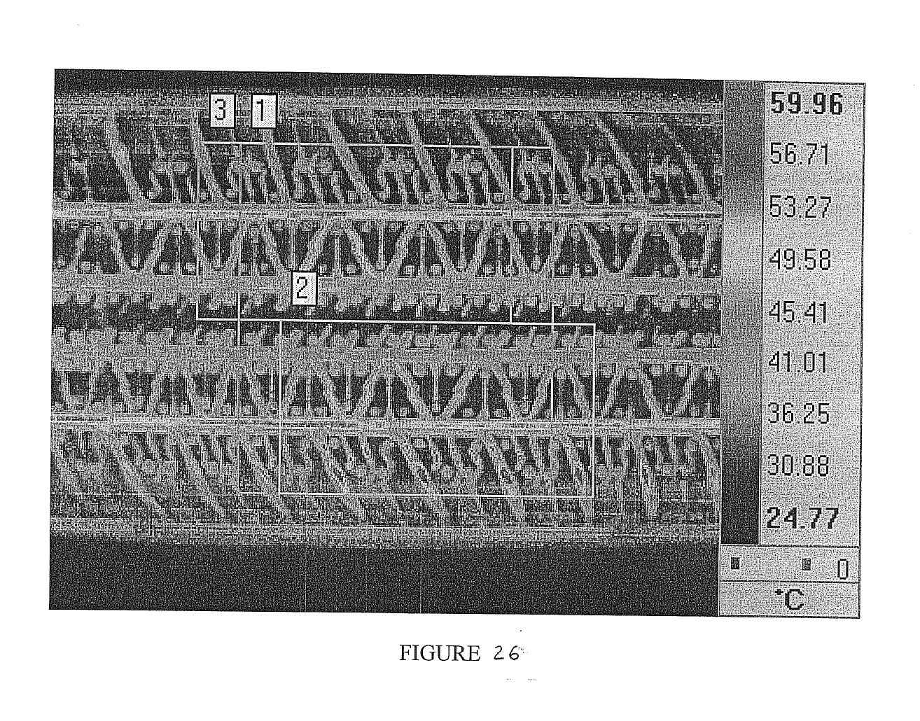

Testing was performed on a P195/65R15 tire of specification code S-100 at 118 mph, under a 987 lbf load, on a 10 foot diameter steel drum, in an ambient temperature of 74 Fahrenheit, inflated to 44 psi until the test reached a steady state temperature. Tires of specification code S-100 have a tread pattern that is point-symmetric. Thermographic data regarding the tire was taken with a Cedip Silver 420M IR camera. Contained air temperature data (CAT) was also taken using a Beru sensor. The point symmetric tread pattern of tire specification code S-100 is shown in FIGS. 23-26. The point symmetric tread pattern of tire specification code S-100 is such that, on one side of the tire, it tends to move air from the shoulder and into the tread, but on the other side of the tire it does not. In a first test run, a tire of specification code S-100 was mounted as shown in FIG. 23, with the serial side out, and was tested with a relative air flow from left to right and with tire circumferential motion from right to left. As shown in FIG. 23, the temperature measured along the side of the tire shown proximate to the bottom of the figure was substantially higher than the temperature measured along the side of the tire shown proximate to the top of the figure. The CAT of the tire in FIG. 23 was 149 Fahrenheit. In a second test run, a tire of specification code S-100 was mounted as shown in FIG. 24, with the serial side out, and was tested with a relative air flow from right to left and with tire circumferential motion from left to right. As shown in FIG. 24, the temperature measured along the side of the tire shown proximate to the bottom of the figure was substantially lower than the temperature measured along the side of the tire shown proximate to the top of the figure. The CAT of the tire in FIG. 24 was 151 Fahrenheit. In a third test run, a tire of specification code S-100 was mounted as shown in FIG. 25, with the serial side in, and was tested with a relative air flow from right to left and with tire circumferential motion from left to right. As shown in FIG. 25, the temperature measured along the side of the tire shown proximate to the bottom of the figure was substantially lower than the temperature measured along the side of the tire shown proximate to the top of the figure. The CAT of the tire in FIG. 25 was 151 Fahrenheit. In a fourth test run, a tire of specification code S-100 was mounted as shown in FIG. 26, with the serial side in, and was tested with a relative air flow from left to right and with tire circumferential motion from right to left. As shown in FIG. 26, the temperature measured along the side of the tire shown proximate to the bottom of the figure was substantially higher than the temperature measured along the side of the tire shown proximate to the top of the figure. The CAT of the tire in FIG. 26 was 154 Fahrenheit. The same tire of specification S-100 was run in all four test runs. It should be noted that the data in Example 5 supports the conclusion that the hot side of the treads pattern switches sides when the rotation direction is switched.

In general, the results of the testing described in Examples 1-5 support the conclusion that tread pattern geometry and shoulder region geometry may create or accentuate air flow over regions of the tire that otherwise would have less air flow and that such air flow may increase cooling of a tire tread region.

It is possible that the above-referenced heat exchange features and their use may be more fully exploited in certain applications. In one non-limiting example of a possible application, certain tire tread patterns that are optimized for hydroplaning resistance are not always simultaneously optimized for induction of cooling air flow into the tire tread. In some embodiments, tire tread patterns that are optimized for hydroplaning resistance but that are not optimized for induction of cooling air flow thereinto could have cooling air flow induction into the tire tread increased by the addition of heat exchange features to one or both shoulder regions of the tire. Further, such heat exchange features may be added to provide cooling air flow to such tires without substantially affecting tread footprint or otherwise trading off hydroplaning resistance. In another non-limiting example of a possible application, heat exchange features may provide for air cooling of both sides of a point symmetric tire tread simultaneously.

While the heat exchange features have been described above in connection with certain embodiments, it is to be understood that other embodiments may be used or modifications and additions may be made to the described embodiments for performing the same function of the tire heat exchange features without deviating therefrom. Further, the tire heat exchange features may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the tire heat exchange features. Therefore, the tire heat exchange features should not be limited to any single embodiment, but rather construed in breadth and scope in accordance with the recitation of the attached claims.

What is claimed is:

1-15. (canceled)

16. A pneumatic tire comprising:
an axis of operational rotation, said operational rotation being either clockwise or counter-clockwise;
a tread defining a substantially cylindrical exterior surface extending both along the axis and around the axis, said tread comprising a tread pattern defined by a tread feature;
a first sidewall defining a first sidewall exterior surface;
a first shoulder region defining a first shoulder exterior surface, said first shoulder region being defined by an area between said tread and said first sidewall;
a heat exchange feature on said first shoulder region adapted to modify air flow over an exterior surface of the tire;
a second sidewall defining a second sidewall exterior surface;
a second shoulder region defining a second shoulder exterior surface, said second shoulder region being defined by an area between said tread and said second sidewall;
a heat exchange feature on said second shoulder region adapted to modify air flow over an exterior surface of the tire; and
wherein,
a) said heat exchange feature on said first shoulder region is adapted to move air during clockwise operational rotation, and said heat exchange feature on said second shoulder region is adapted to move air during clockwise operational rotation; or
b) said heat exchange feature on said first shoulder region is adapted to move air during counter-clockwise operational rotation, and said heat exchange feature on said second shoulder region is adapted to move air during counter-clockwise operational rotation.

17. The pneumatic tire of claim 16, wherein
said tread feature is defined by a rib, a groove, slot, a block, or a sipe;
said heat exchange feature on said first shoulder region is defined by a rib, a groove, slot, a block, or a sipe; and
said heat exchange feature on said second shoulder region is defined by a rib, a groove, slot, a block, or a sipe.

18. The pneumatic tire of claim 17, wherein
said tread pattern is defined by a plurality of tread features;
said first shoulder region comprises a plurality of heat exchange features on said first shoulder region; and
said second shoulder region comprises a plurality of heat exchange features on said second shoulder region.

19. The pneumatic tire of claim 18, wherein
said plurality of heat exchange features on said first shoulder region,
are adapted to move air from the first shoulder region to the tread during clockwise operational rotation, and
are adapted to move air from the first shoulder region to the tread during counter-clockwise operational rotation; and
said plurality of heat exchange features on said second shoulder region,
are adapted to move air from the second shoulder region to the tread during clockwise operational rotation, and
are adapted to move air from the second shoulder region to the tread during counter-clockwise operational rotation.

20. The pneumatic tire of claim 19, wherein
the heat exchange features on said first shoulder region gradually transition into the tread features; or
the heat exchange features on said second shoulder region gradually transition into the tread features.

21. The pneumatic tire of claim 18, wherein
during operational rotation in a first direction,
said plurality of heat exchange features on said first shoulder region move air from the first shoulder region into one or more slots or grooves of the tread pattern, and
said plurality of heat exchange features on said second shoulder region move air from the second shoulder region into one or more slots or grooves of the tread pattern; and
during operational rotation in a second direction opposite said first direction,
said plurality of heat exchange features on said first shoulder region do not move air from the first shoulder region into one or more slots or grooves of the tread pattern, and
said plurality of heat exchange features on said second shoulder region do not move air from the second shoulder region into one or more slots or grooves of the tread pattern.

22. The pneumatic tire of claim 21, wherein
the heat exchange features on said first shoulder region are integrally connected with, and transition into, analogous tread features; or
the heat exchange features on said second shoulder region are integrally connected with, and transition into, analogous tread features.

23. The pneumatic tire of claim 22, wherein
the heat exchange features on said first shoulder region have a directional bias; and
the heat exchange features on said second shoulder region have a directional bias.

24. The pneumatic tire of claim 23, wherein
the heat exchange features on said first shoulder region are curved; and
the heat exchange features on said second shoulder region are curved.

25. A method of cooling a tread of a pneumatic tire comprising:
providing a pneumatic tire, said pneumatic tire comprising,
an axis of operational rotation, said operational rotation being either clockwise or counter-clockwise;
a tread defining a substantially cylindrical exterior surface extending both along the axis and around the axis, said tread comprising a tread pattern defined by a tread feature;
a first sidewall defining a first sidewall exterior surface;
a first shoulder region defining a first shoulder exterior surface, said first shoulder region being defined by an area between said tread and said first sidewall;
a heat exchange feature on said first shoulder region adapted to modify air flow over an exterior surface of the tire;
a second sidewall defining a second sidewall exterior surface;
a second shoulder region defining a second shoulder exterior surface, said second shoulder region being defined by an area between said tread and said second sidewall;
a heat exchange feature on said second shoulder region adapted to modify air flow over an exterior surface of the tire; and
wherein,
a) said heat exchange feature on said first shoulder region is adapted to move air during clockwise operational rotation, and said heat exchange feature on said second shoulder region is adapted to move air during clockwise operational rotation; or
b) said heat exchange feature on said first shoulder region is adapted to move air during counter-clockwise operational rotation, and said heat exchange feature on said second shoulder region is adapted to move air during counter-clockwise operational rotation;
subjecting said tire to operational rotation, said operational rotation being either clockwise or counter-clockwise;
during said operational rotation, moving a first quantity of air with said heat exchange feature on said first shoulder region to the tread of the tire;
cooling said tread with said first quantity of air;
during said operational rotation, moving a second quantity of air with said heat exchange feature on said second shoulder region to the tread of the tire; and
cooling said tread with said second quantity of air.

26. The method of cooling a tread of a pneumatic tire of claim 25, wherein
said tread feature is defined by a rib, a groove, slot, a block, or a sipe;
said heat exchange feature on said first shoulder region is defined by a rib, a groove, slot, a block, or a sipe; and
said heat exchange feature on said second shoulder region is defined by a rib, a groove, slot, a block, or a sipe.

27. The method of cooling a tread of a pneumatic tire of claim 26, wherein
said tread pattern is defined by a plurality of tread features;
said first shoulder region comprises a plurality of heat exchange features on said first shoulder region; and
said second shoulder region comprises a plurality of heat exchange features on said second shoulder region.

28. The method of cooling a tread of a pneumatic tire of claim 27, wherein
said plurality of heat exchange features on said first shoulder region,
are adapted to move air from the first shoulder region to the tread during clockwise operational rotation, and
are adapted to move air from the first shoulder region to the tread during counter-clockwise operational rotation; and
said plurality of heat exchange features on said second shoulder region,
are adapted to move air from the second shoulder region to the tread during clockwise operational rotation, and
are adapted to move air from the second shoulder region to the tread during counter-clockwise operational rotation.

29. The method of cooling a tread of a pneumatic tire of claim 28, wherein
the heat exchange features on said first shoulder region gradually transition into the tread features; or
the heat exchange features on said second shoulder region gradually transition into the tread features.

30. The method of cooling a tread of a pneumatic tire of claim 27, wherein
during operational rotation in a first direction,
said plurality of heat exchange features on said first shoulder region move air from the first shoulder region into one or more slots or grooves of the tread pattern, and
said plurality of heat exchange features on said second shoulder region move air from the second shoulder region into one or more slots or grooves of the tread pattern; and
during operational rotation in a second direction opposite said first direction,
said plurality of heat exchange features on said first shoulder region do not move air from the first shoulder region into one or more slots or grooves of the tread pattern, and
said plurality of heat exchange features on said second shoulder region do not move air from the second shoulder region into one or more slots or grooves of the tread pattern.

31. The method of cooling a tread of a pneumatic tire of claim 30, wherein
the heat exchange features on said first shoulder region are integrally connected with, and transition into, analogous tread features; or
the heat exchange features on said second shoulder region are integrally connected with, and transition into, analogous tread features.

32. The method of cooling a tread of a pneumatic tire of claim 31, wherein
the heat exchange features on said first shoulder region have a directional bias; and
the heat exchange features on said second shoulder region have a directional bias.

33. The method of cooling a tread of a pneumatic tire of claim 32, wherein
the heat exchange features on said first shoulder region are curved; and
the heat exchange features on said second shoulder region are curved.

34. A pneumatic tire comprising:
an axis of operational rotation, said operational rotation being either clockwise or counter-clockwise;
a tread defining a substantially cylindrical exterior surface extending both along the axis and around the axis, said tread comprising a tread pattern defined by a plurality of tread features, said tread features defined by a rib, a groove, slot, a block, or a sipe;
a first sidewall defining a first sidewall exterior surface;
a first shoulder region defining a first shoulder exterior surface, said first shoulder region being defined by an area between said tread and said first sidewall;
a plurality of heat exchange features on said first shoulder region, wherein each heat exchange feature on said first shoulder region is adapted to modify air flow over an exterior surface of the tire, said heat exchange features on said first shoulder region defined by a rib, a groove, slot, a block, or a sipe, said plurality of heat exchange features on said first shoulder region,
being adapted to move air from the first shoulder region to the tread during clockwise operational rotation, and
being adapted to move air from the first shoulder region to the tread during counter-clockwise operational rotation;
a second sidewall defining a second sidewall exterior surface;
a second shoulder region defining a second shoulder exterior surface, said second shoulder region being defined by an area between said tread and said second sidewall;
a plurality of heat exchange features on said second shoulder region, wherein each heat exchange feature on said second shoulder region is adapted to modify air flow over an exterior surface of the tire, said heat exchange features on said second shoulder region defined by a rib, a groove, slot, a block, or a sipe, said plurality of heat exchange features on said second shoulder region,
being adapted to move air from the second shoulder region to the tread during clockwise operational rotation, and
being adapted to move air from the second shoulder region to the tread during counter-clockwise operational rotation; and
wherein,
a) said heat exchange feature on said first shoulder region is adapted to move air during clockwise operational rotation, and said heat exchange feature on said second shoulder region is adapted to move air during clockwise operational rotation; or
said heat exchange feature on said first shoulder region is adapted to move air during counter-clockwise operational rotation, and said heat exchange feature on said second shoulder region is adapted to move air during counter-clockwise operational rotation; and
b) the heat exchange features on said first shoulder region gradually transition into the tread features; or
the heat exchange features on said second shoulder region gradually transition into the tread features.

35. A pneumatic tire comprising:
an axis of operational rotation, said operational rotation being either clockwise or counter-clockwise;
a tread defining a substantially cylindrical exterior surface extending both along the axis and around the axis, said tread comprising a tread pattern defined by a plurality of tread features, said tread features defined by a rib, a groove, slot, a block, or a sipe;
a first sidewall defining a first sidewall exterior surface;
a first shoulder region defining a first shoulder exterior surface, said first shoulder region being defined by an area between said tread and said first sidewall;
a plurality of heat exchange features on said first shoulder region, wherein each heat exchange feature on said first shoulder region is adapted to modify air flow over an exterior surface of the tire, said heat exchange features on said first shoulder region,
are defined by a rib, a groove, slot, a block, or a sipe,
have a directional bias,
are curved,
are integrally connected with, and transition into, analogous tread features, and
during operational rotation in a first direction, said plurality of heat exchange features on said first shoulder region move air from the first shoulder region into one or more slots or grooves of the tread pattern, and
during operational rotation in a second direction opposite said first direction, said plurality of heat exchange features on said first shoulder region do not move air from the first shoulder region into one or more slots or grooves of the tread pattern, and
a second sidewall defining a second sidewall exterior surface;
a second shoulder region defining a second shoulder exterior surface, said second shoulder region being defined by an area between said tread and said second sidewall;
a plurality of heat exchange features on said second shoulder region, wherein each heat exchange feature on said second shoulder region is adapted to modify air flow over an exterior surface of the tire, said heat exchange features on said second shoulder region
are defined by a rib, a groove, slot, a block, or a sipe,
have a directional bias,
are curved,
are integrally connected with, and transition into, analogous tread features, and
during operational rotation in a first direction, said plurality of heat exchange features on said second shoulder region move air from the second shoulder region into one or more slots or grooves of the tread pattern; and
during operational rotation in a second direction opposite said first direction, said plurality of heat exchange features on said second shoulder region do not move air from the second shoulder region into one or more slots or grooves of the tread pattern; and
wherein,
said heat exchange feature on said first shoulder region is adapted to move air during clockwise operational rotation, and said heat exchange feature on said second shoulder region is adapted to move air during clockwise operational rotation; or
said heat exchange feature on said first shoulder region is adapted to move air during counter-clockwise operational rotation, and said heat exchange feature on said second shoulder region is adapted to move air during counter-clockwise operational rotation.
